(19) United States
(12) Patent Application Publication
(10) Pub. No.: US 2023/0399933 A1
(43) Pub. Date: Dec. 14, 2023

(54) OIL AND NATURAL GAS DRILL SCHEDULE OPTIMIZATION

(71) Applicant: INVENTUS HOLDINGS, LLC, Juno Beach, FL (US)

(72) Inventors: Taran Raj, St. Paul, MN (US); Jon Renner, Little Canada, MN (US); Ross Weinstein, Woodbury, MN (US); Michael Osterlie, Burnsville, MN (US); Jack Stubbs, Houston, TX (US); Brittany Pitlik, Houston, TX (US); Gordon Paynter, Falcon Heights, MN (US); Emmanuel Resch, Miami, FL (US)

(21) Appl. No.: 17/839,757

(22) Filed: Jun. 14, 2022

(51) Int. Cl. E21B 44/00; G06Q 10/10

(52) U.S. Cl. CPC E21B 44/00; G06Q 10/103; E21B 2200/22; E21B 2200/20

(57) ABSTRACT

Disclosed is a system and method for improving oil and gas drilling scheduling. A plurality of project projections is performed by accessing data elements, each associated with criteria. Each of the criteria is used to project expected gas production from gas wells, and the criteria include a number of crews to perform jobs and a total number of jobs. The criteria are converted into a uniform data format. Next, a total number of simulations (M) are executed in parallel up to the total number of jobs or until a time period expires. The simulations include evaluating each of the jobs to be performed and which crews are available to perform jobs and executing an algorithm to produce results, wherein the results include a schedule of crews and jobs and a production timeline. The results are ranked with the highest gas production. The results are sent to a display.

### FIELD OF THE DISCLOSURE

The present invention generally relates to a method of analyzing an oil and gas production project and, more particularly, relates to an oil and gas management program for designing a production project and analyzing equipment requirements, costs, and other information associated with the project.

### BACKGROUND

To produce natural gas, companies enter land leases to gain access to mineral rights. Different crews are then dispatched to construct drill pads, drill horizontal wells into rock, pressurize the wells by plugging them to perform hydraulic fracturing and finally drill out the plugs to extract natural gas, oil, and natural gas liquids. A typical production field may require several years of drilling to develop a half dozen wells that are expected to be in production for 10 to 15 years.

Unconventional shale wells are drilled using 21^{st}-century vertical or horizontal technologies. Vertical wells are sometimes first drilled in an area to obtain information valuable for planning the drilling of more costly and technically demanding horizontal wells.)

Prior to drilling an unconventional shale well, operators must obtain several permits and adhere to a number of local, state and federal laws and regulations from constructing the well pad, building the access drive and constructing and operating the well itself.

The drilling process focuses first on reaching—and protecting—water-bearing zones beneath the ground. Drilling is completed using a small amount of lubricating agents. The entire length of the well, from the surface to the groundwater strata, is cased and cemented tightly with a series of steel pipes and concrete to form a barrier between the wellbore and the earth. As drilling continues to push deeper into the earth, a series of long drilling pipes follow it to establish the well.

After drilling vertically to the depth that reaches slightly above the targeted unconventional shale formation, the drill bit can then turn to push its way horizontally into the unconventional shale formation, sometimes as much as 10,000 to 15,000 feet into the formation. This allows for the extraction of larger quantities of natural gas from a single wellhead. Unconventional shale wells generally take between 15 to 30 days to drill, depending on the timetable of the individual operator.

Historically, the production planning activities have been manually intensive, rely heavily on experiential knowledge, and focus on a short-term time horizon of one year or less. In order to determine the final schedule, a planner models various scenarios in a spreadsheet to ensure operational constraints are respected. At the end of the planning process, there is no way to determine if the final schedule is optimal because of a large number of combinatorial factors are not solvable by a human with a spreadsheet.

### SUMMARY OF THE INVENTION

The claimed invention is a scheduling system that optimizes a company's schedule planning process to maximize production from their natural gas leases and wells. The invention uses an algorithm that efficiently solves for high-value scenarios over a long-term time horizon and allows for the flexibility required.

The present invention provides a novel method and system for improving oil and gas drilling scheduling. A plurality of project projections are performed by accessing data elements, each associated with criteria.

In one example, the criteria used to project expected gas production includes 1) location of a gas well, 2) expected length of a gas well, 4) a location of a pad, 5) an identifier of a basin to which a pad belongs, 6) an identifier of a lease for any timing constraints, 7) types of jobs at a pad, 8) a number of days allocated to perform a job, 9) a number of days each pad is in a recovery state, or 10) any combination thereof.

Next, each of the criteria is used to project expected gas production from gas wells, and the criteria include a number of crews to perform jobs and a total number of jobs. The criteria are converted into a uniform data format. Next, a total number of simulations (M) are executed in parallel up to the total number of jobs or until a time period expires. The total number of simulations, the time period, or both are settable by a user.

The simulations include evaluating each of the jobs to be performed and which crews are available to perform the jobs and executing an algorithm to produce results, wherein the results include a schedule of crews and jobs and a production timeline. The results are ranked with the highest gas production. The results are sent to a display. The algorithm may be selectable by a user. The algorithm is an epsilon-greedy algorithm or a random algorithm.

In one example, the results from each step using the epsilon-greedy algorithm is given by:

$${score}_{p} = {exp}^{ϵ * {weight}_{p}} / {\sum }_{n = 1}^{P} {exp}^{ϵ * {weight}_{p}}$$

$${weight}_{p} = ( {\sum }_{n = 1}^{N} {w}_{n} {x}_{n} / {\sum }_{n = 1}^{N} {w}_{n} ) ∀ P$$

where p is a pad in a set P of all pads being scored, wₙ is a user-specified weight of each of the plurality of criteria N, and xₙ is a computed value of each of i) maximum expected production from each pad, ii) the work already completed on the pad if any, iii) an estimated likelihood of a frack hit, and iv) time remaining before the pad must be developed. The wₙ is assigned by a user using a graphical user interface.

The results sent to the display may include 1) a table of jobs, with a crew performing the job and start and end times for each job, 2) an expected cash flow time-series, 3) an expected production time-series, 4) events table that specifies a date of initial production of each well and any shut-ins that occur in that schedule with their duration and production impact, 6) constraint violations, 7) water usage, 8) net present value (NPV) of gas production, 8) internal rate of return (IRR) of gas production or 10) any combination thereof.

The results may include a Gantt chart with a vertical axis denoting a pad, and a horizontal axis including jobs, the crews performing the jobs and the start and end job times at each pad denoted in various colors.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1A illustrates drilling rigs for natural gas and oil production, according to an example of the present invention;

FIG. 1B illustrates drilling rigs for natural gas and oil production for unconventional wells, according to an example of the present invention;

FIG. 2 is an aerial map with an overlay of potential drilling alternatives for a given geographic area, according to an example of the present invention;

FIG. 3 is a flow diagram of the major process for natural gas drill and completion schedule optimization, according to an example of the present invention;

FIG. 4A and FIG. 4B, shown is a scatter plot of net dry gas production on the Y-axis and NPV on the X-axis, according to an example of the present invention;

FIG. 5A and FIG. 5B, shown is a user interface with four quadrants, according to one example of the present invention;

FIG. 6A and FIG. 6B, shown is an expected run format to check for each data element, according to one example of the present invention;

FIG. 7A and FIG. 7B, is another user-interface example with Gantt schedules for a given episode or run, according to an example of the present invention; and

FIG. 8 illustrates a block diagram illustrating a processing system for carrying out portions of the present invention, according to an example of the present invention,

### DETAILED DESCRIPTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

Generally, the terms “a” or “an”, as used herein, are defined as one or more than one. The term plurality, as used herein, is defined as two or more than two.

The term “adapted to” describes the hardware, software, or a combination of hardware and software that is capable of, able to accommodate, to make, or that is suitable to carry out a given function.

The term “another”, as used herein, is defined as at least a second or more.

The term “completion schedule” as applied to natural gas and oil production means all steps necessary in site selection, site construction, site drilling, site hydraulic fracturing and gas/oil production over the lifetime of the well.

The term “configured to” describes hardware, software or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “crew” means a group of people who work on a portion of a completion schedule together for a period of time.

The terms “including” and “having,” as used herein, are defined as comprising (i.e., open language).

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “simultaneous” means computations are carried out at the same time, which for larger data sets with various constraints is not possible to be carried out completed by a group of humans and must be performed by a computer. For example, one human could not compute one simulation with all the constraints for ten crews across fifty ten jobs. It is infeasible for a human to calculate one simulation loop with one constraint, let alone perform it in parallel to a sort of global optimum.

The term “uniform data format” means data in a given format, whether date format, time format, currency format, scientific format, text format, or fractional format, so that all values of data are presented in a single consistent format for a given category or criteria.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

Although the elements in the following method claims, if any, are recited in a particular sequence with corresponding labeling unless the claim recitations otherwise imply a particular sequence for implementing some or all of those elements, those elements are not necessarily intended to be limited to being implemented in that particular sequence.

### Overview

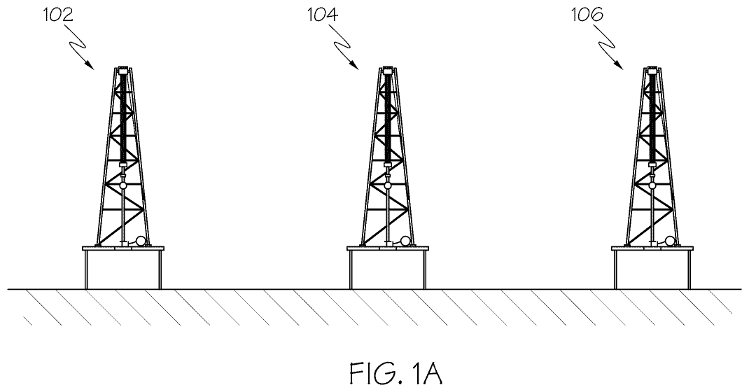

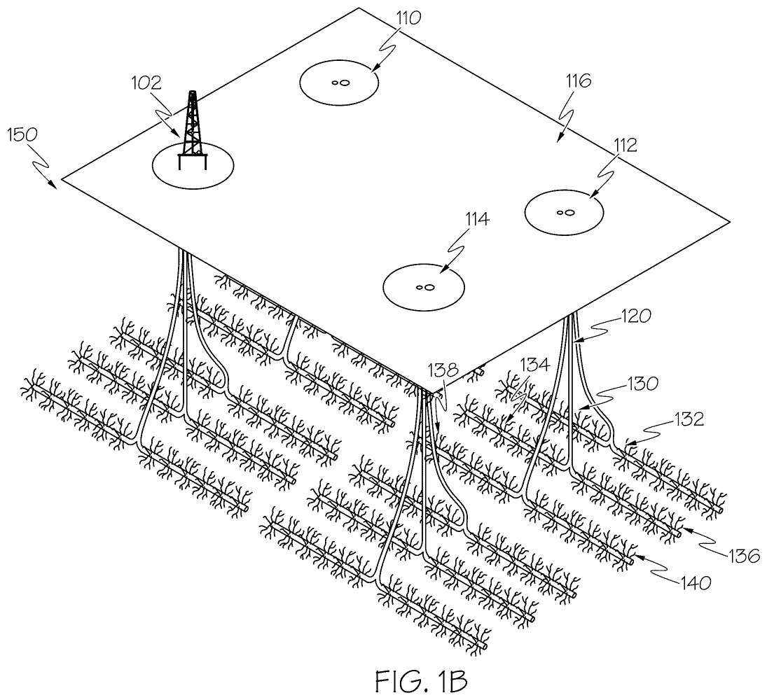

The claimed invention is a scheduling system that optimizes a company's schedule planning process to maximize production from their natural gas leases and wells. The invention uses an algorithm that efficiently solves for high-value scenarios over a long-term time horizon and allows for the flexibility required. FIG. 1 drilling rigs for natural gas and oil production, according to an example of the present invention.

Drilling rigs 102, 104, 106, such as those shown in FIG. 1A are used for both conventional resources and unconventional resources. However, conventional and unconventional resource production are very different. Both refer to some quantity of fossil fuels that could contribute to a reserve if they could be extracted economically. The difference between conventional and unconventional is relatively straightforward and has to do mostly with the ease the fuels can be extracted with.

Conventional oil or gas comes from formations that are “normal” or straightforward to extract products from. Extracting fossil fuels from these geological formations can be done with standard methods that can be used to economically remove the fuel from the deposit. Conventional resources tend to be easier and less expensive to produce simply because they require no specialized technologies and can utilize common methods. Because of this simplicity and relative cheapness, conventional oil and gas are generally some of the first targets of industry activity.

FIG. 1B illustrates drilling rigs for natural gas and oil production for unconventional wells, according to an example of the present invention. Developments in drilling methods and technology are leading to efficiency gains for oil and natural gas producers. For example, “pad” drilling techniques allow rig operators to drill groups of wells more efficiently, because improved rig mobility reduces the time it takes to move from one well location to the next, while reducing the overall surface footprint. A drilling pad is a location which houses the wellheads 110, 112, 114 for a number of horizontally drilled wells 120. The benefit of a drilling pad is that operators can drill multiple wells in a shorter time than they might with just one well per site.

FIG. 1B illustrates two levels, a surface level 116 and a below ground level 150. This illustrates widespread underground development by concentrating wellheads 110, 112, 114, after a drilling operation at the surface 116. Also shown is a drilling rig 102 drilling the well. Notice that there are multiple wells connected to each well head. For example, well head 112, has three wells 120 each with horizontal branches 120, 132, 134, 136 as shown.

Moving a drilling rig 102 between two well sites previously involved disassembling the rig and reassembling it at the new location (“rigging down” and “rigging up”) even if the new location was only a few yards away. Today, a drilling pad may have five to ten wells, which are horizontally drilled in different directions, spaced fairly close together at the surface. Once one well is drilled, the fully constructed rig can be lifted and moved a few yards over to the next well location using hydraulic walking or skidding systems.

In FIG. 1B, each of the three drilling pads 110, 112, 114 hosts six horizontal wells 130, 132, 134, 136, 140. Pad drilling allows producers to target a significant area of underground resources while minimizing the impact on the surface. Concentrating the wellheads also helps the producer reduce costs associated with managing the resources above-ground and moving the production to market.

In contrast to this, unconventional oil or gas resources are much more difficult to extract. Some of these resources are trapped in reservoirs with poor permeability and porosity, meaning that it is extremely difficult or impossible for oil or natural gas to flow through the pores and into a standard well. To be able to produce from these difficult reservoirs, specialized techniques and tools are used. For example, the extraction of shale oil, tight gas, and shale gas must include a hydraulic fracturing step in order to create cracks for the oil or gas to flow through. In the oil sands, in situ deposits must utilize steam-assisted gravity drainage to be able to extract thick bitumen from underground deposits. All of these methods are more costly than those used to produce fossil fuels from a traditional reservoir, but this stimulation allows for the production of oil and gas from resources that were previously not economical to extract from. These resources become reserves when they can be utilized economically.

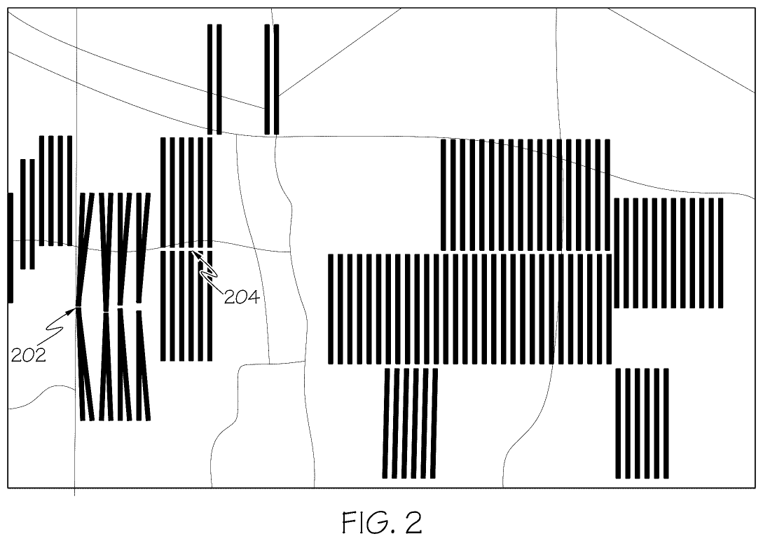

FIG. 2 is an aerial map with an overlay of potential drilling alternatives for a given geographic area, according to an example of the present invention. Note that in this example, there are two types of lines shown that represent the same type of un-conventional drilling of wells with a set of lines/wells assigned to each pad (not shown) The vertex 202 of the V-shaped lines represents a location of a drilling rig. Likewise, starting point 204 represents the location of the drilling rig for parallel lines. The length of each line represents the length of the horizontal well lengths and where the well starts and ends to correspond to geocoordinates such as latitude and longitude.

This starting point and ending point of each well location information is used made available to create this overlay plot for all the possibilities for that geographic location. The simulation environment or scheduling system models the impact of the sequencing of oil and natural gas well production (“simultaneous operations”), which is of vital importance to the planning process. The oil and natural gas well information is important for this sequencing because there are constraints based on the location of well. An example of a constraint is that two given wells may not have specific jobs performed on them simultaneously if they are within a given geographic distance from each other. An example of this is that a well cannot be drilled if a nearby well is being completed/hydraulically fractured (fracked)

### Overview of Drilling Optimization

The present invention may employ a reinforced learning approach to optimize drilling completion schedules. However, after further investigation, the reinforced learning approach was paused, and heuristic techniques were developed, including a random and epsilon-greedy algorithm approach.

The algorithm leverages an Epsilon Greedy Agent with inputs to model the financial, contractual, and operational constraints of the planning process. Financial constraints ensure that computed schedules do not exceed the budget for labor and equipment. Contractual and operational constraints guarantee adherence to land lease terms, safety considerations, and factors in the availability of crews and materials needed for production.

The simulation environment or scheduling system also models the impact of drilling and completion on wells that are nearby already producing natural gas wells (“shut in process”), which is of vital importance to the planning process. Extraction activities in each oil and natural gas well can significantly impact the production of nearby wells—similar to wind turbine waking effects, in which resource capture at one turbine can affect those of nearby turbines.

After the environment is configured, an Epsilon Greedy Agent iterates through possible choices of crews and available jobs over the forecast horizon and ranks potential scheduling decisions by value.

Most of the time, the Epsilon Greedy Agent selects the highest value decision. However, there is a small chance that the Epsilon Greedy Agent will make a lower value decision that could unlock additional hidden value in subsequent time steps. This type of combined random & greedy decision-making is a simple technique that allows the Epsilon Greedy Agent to arrive at high-value drilling schedules over many iterations. An advantage of using the Epsilon Greedy Agent versus a more traditional constrained optimization framework is that Epsilon Greedy Agent quickly accommodates rapidly changing (and new) constraints and objective functions.

The scheduling system includes a user interface (UI) that streamlines the planning process. Users can enter the oil and natural gas well data, like location and production potential, then kick off simulations. Simulations are typically complete in a matter of minutes and solve for schedules up to five years out.

The UI displays output in the form of expected production (Net Dry Gas), net present value (NPV), cash flow forecasts, and crew schedules. The user can evaluate each of the scenarios to select a plan, taking into consideration evolving business preferences. The UI is intuitive and allows for fast parsing through up to a thousand scenarios to find a schedule that meets customer preferences for crew utilization, production profile, and simultaneous operations.

Companies often have some uncertainty in the metric to maximize. This stems from an unclear understanding of all the components applied to estimate the NPV of a project schedule. On the other hand, total gas production appears to be a preferred metric but doesn't answer significant questions surrounding expected future gas revenues and the time value of money, particularly since the production curves typically go out over 50 years. To address these questions and uncertainty, the scheduling system of the claimed invention applies a heuristic algorithm that maximizes production by generating multiple schedules with slight variations and allowing the user to select the best performing schedule either based on total gas production or NPV since they are positively correlated.

Inputs to the scheduling system of the claimed invention include:
Gas Wells—Their locations (latitude/longitude), expected length, etc.
Pads—Gas wells are drilled at pads where a drilling rig is located. Typically, there are between 3-6 wells per pad
Basin—That the pads belong to which describe a larger geographical area where capital is deployed per year
Land Lease—That the Pads belong to which impose specific constraints outlined below
Water Basin—That the pads belong to which describe specific frack water constraints described below. The water basins replenish water at a pre-determined rate
Jobs—At each pad (Job types are pad construction, drilling, fracking, and plug drill out)
The number of days to perform the job
The number of days after the job that the pad is in a “recovery” state and cannot have the next job performed on it
The capital required to perform the job
Production forecasts—For each gas well
Gas prices—For all wells
Crews—Of each type (pad construction, drilling, fracking and plug drill out) available to perform the jobs at some subset of basins

Outputs produced by the scheduling system of the claimed invention include:
A table of jobs, with the crew performing the job and start and end times for each job
The expected cash flow time series (daily and monthly)
The expected production time series (daily and monthly)
An events table that specifies the date of the first production of each well and any shut-ins that occur in that schedule with their duration and production impact

Physical Constraints
All jobs must be performed in a pre-determined fixed order
   Pads are first constructed, then the wells are drilled, followed by hydraulic fracturing (or fracking), and finally, the plug drill-out operation is performed to flow the gas
For safety reasons, a drill operation cannot be performed near a fracking or plug drill-out operation and vice versa
For safety reasons, a plug drill-out operation cannot be performed near a fracking operation and vice-versa
Cannot perform the jobs on a pad that is in a “recovery” state after a prior job has been completed
A producing well must be “shut-in” for the duration of an offset fracking operation
Shut-in wells return at some new production level relative to their (typically 90%) of their expected production. This is due to gas pressure losses in a well from an offset frack
All jobs and crews have a type/skill. A crew may only perform a job with a matching type/skill
A pad's water reservoir must contain enough frack water to begin the completion process

Business Requirements
All wells at a pad are developed concurrently
A subset of all the wells (on the same land lease) may have additional requirements, for instance,
   That some specified job type must be performed at least one of the wells in that lease by a given date
   That no job of a specified type may be performed at any of the wells in that lease before, between or after some given dates
Capital limits may be specified per basin (a subset of all the wells) per year that limits the number of jobs that can be performed at the basin in that year
The crews performing the jobs may be unavailable before, during or after some given dates
Crews may only perform the jobs on wells in the basins in which they are allowed to operate

### Software Environment

The scheduling system is a custom Open AI Gym environment and implements the required step and reset public methods. When the scheduling system is initialized, it requires the inputs listed above, e.g., a list of crews, pads, basins, leases, water basins, and the episode start time. Also, other inputs described above—The crews, pads, basins, leases, and water basins are distinct classes in the code. They require other data (such as wells, jobs, capital expenditures (CAPEX), etc.) to initialize them.

After initialization, the step method can be called with an action that conforms to the scheduling systems' action space. The scheduling system environment action space is,
The action space is a MultiDiscrete space (from gym.spaces) of the form [c_1, c_2, c_n] where c_1, c_2, c-n are the n crews in the simulation, and each c_* value can be a discrete non-negative integer id of the pad (0 to p-1 when there are p pads) to which the crew is to be sent. c_* can also take a value of p which will cause the crew to be sent to the service center and wait.

When a “step” is called with an appropriate action, the scheduling system will check the validity of the action against all the physical and business requirements. If the action is valid, each crew is assigned to the first available job at the specified pad (all jobs are sequential). The scheduling system then moves to the next logical time step and repeats its crew assignment and crew, pad, and production update steps until at least one crew is free to be assigned a new job AND the episode is not complete. If true, the method returns a tuple of,
Observation, a tuple of,
   Percentage of job completion by JobType at each pad
   The pad options for all each available crew
Days since start
Reward—the sum of discounted cash flow
Done flag
Logging data

And waits for the next action from the agent. An episode is considered complete when all the jobs at all pads are done, at which point the reset method can be called and will return the scheduling system to its initial state.

### Algorithms or Agents

The present invention uses one or two algorithms or agents to implement the claimed scheduling system.
1) Random Agent
   Takes random actions at each step when interacting with the scheduling system until the episode is complete. Used primarily for testing.
2) Epsilon Greedy Agent
   A specific implementation of an epsilon greedy agent which takes greedier or more random actions at each step based on the observation received from the scheduling system and the epsilon hyper-parameter initialized for the agent. As the epsilon is increased, the agent gets greedier while the reverse will incentivize more random behavior.
   The hyper-parameter epsilon is used to estimate a score for each pad as,

$${score}_{p} = {exp}^{ϵ * {weight}_{p}} / {\sum }_{n = 1}^{P} {exp}^{ϵ * {weight}_{p}}$$

$${weight}_{p} = ( {\sum }_{n = 1}^{N} {w}_{n} {x}_{n} / {\sum }_{n = 1}^{N} {w}_{n} ) ∀ P$$

Where p is a pad in the set P of all pads being scored, wₙ is the user specified weight/importance of each of the N criteria and xₙ is the computed value of each of the criteria described below,

For each agent type 1) Random Agent and 2) Epsilon Greedy Agent
Maximum expected production from each pad
The work already completed on the pad if any
An estimated likelihood of a frack hit
Time remaining before the pad must be developed

Comparing Agent Performance. In every metric, the Epsilon Greedy Agent outperformed the Random Agent.

### Flow Overview

Each “Project” is comprised of a plurality of data elements, including pads, gas wells, basins, land leases, water reservoirs, jobs, crews, the expected gas, oil and NGL production per well, and a time-series of prices for gas, oil and natural gas liquids (NGL). Each pad is comprised of a plurality of gas wells. Basins, land leases, and water reservoirs contain a plurality of pads. Multiple jobs are to be performed at each pad by one of the available crews (pad construction, drilling, fracking, plug drill-out) until all jobs are completed. The claimed invention performs numerous simulations in parallel per project. Each simulation has the number of steps divided into a per simulation loop and a per project loop as follows.

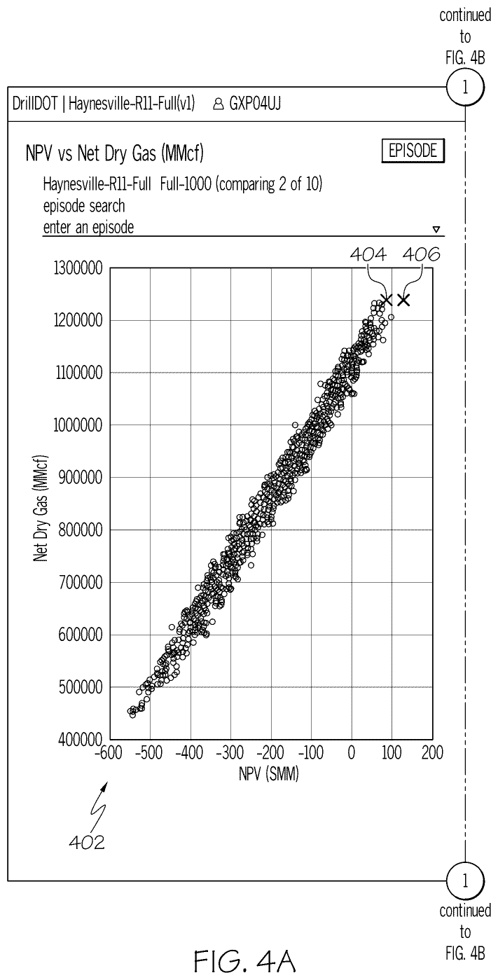

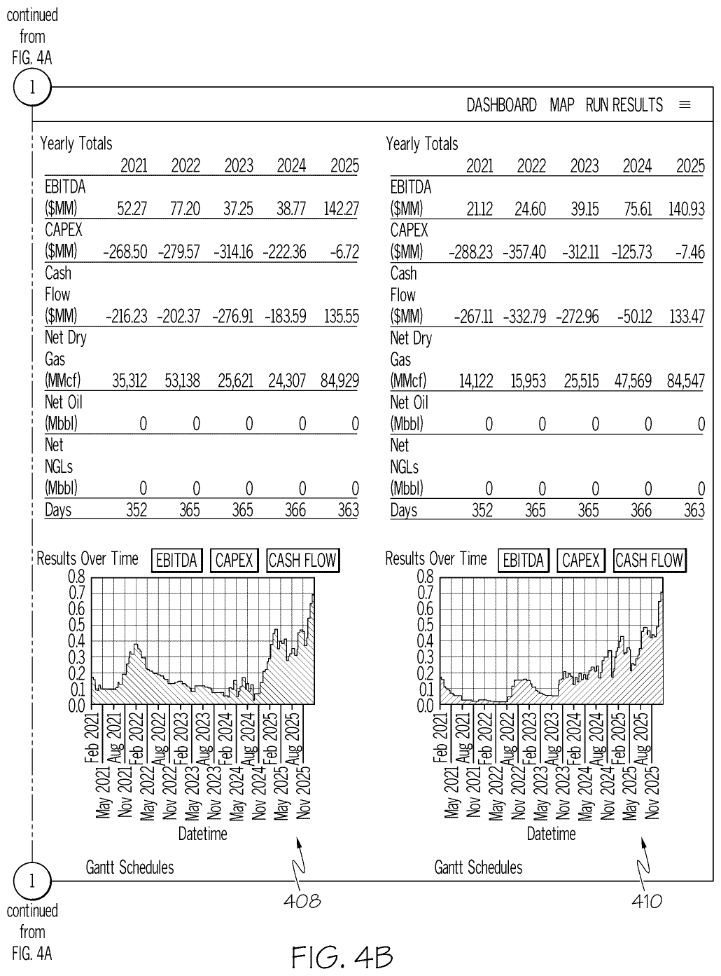

Per Simulation Loop:
1. At each time, evaluate all jobs that can be performed, the crews available, the time required to complete the job, and all constraints that may be violated if the job is performed
2. Run selected algorithm to evaluate step 1. And select the jobs to be performed and the crews to be assigned to the jobs
3. Repeat 2-3 until all jobs are completed, or a terminating condition is reached. For example, the time window expires, or the simulation reaches an infeasible state
4. Produce results—Schedule of crews and jobs, the gas, oil and NGL production timeline, water usage, any recorded constraint violations, shut-in time periods by oil and natural gas well, if any, other financial metrics like NPV, internal rate of return (IRR), etc.
This is shown in user-interactive and user-selectable interfaces FIG. 4A and FIG. 4B through FIG. 7A and FIG. 7B.

Project Loop:
1. Pick an algorithm—Random or Epsilon Greedy
2. Acquire data elements and convert them into a uniform data format
3. Pick how many simulations or episodes to run call it M
4. Run M simulation loops in parallel
5. Evaluate the total production for all simulations to display the best performing/highest gas production simulations

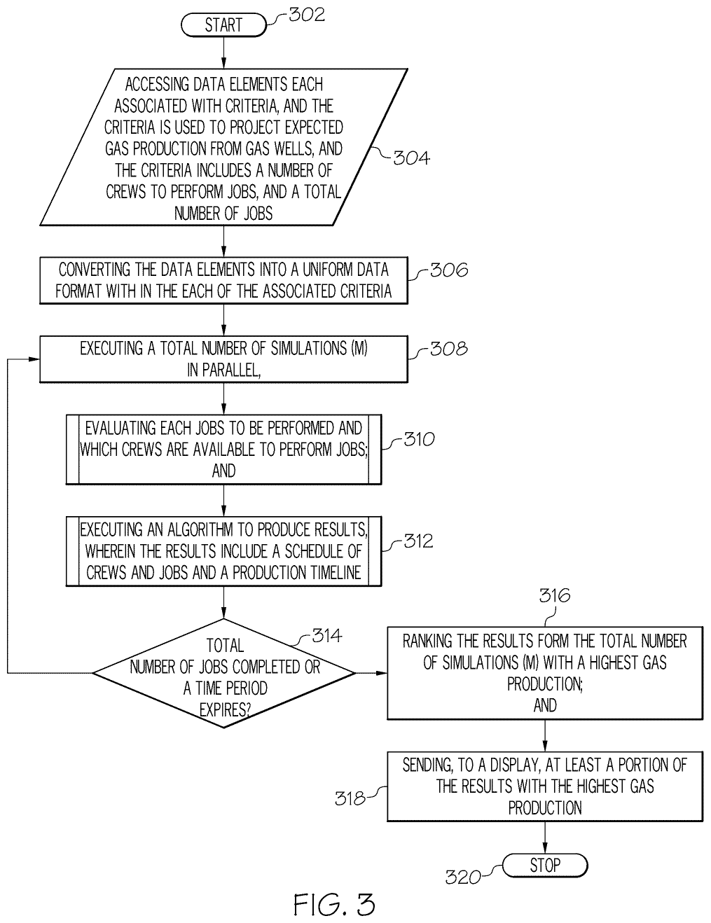

Turning now to FIG. 3, shown is a flow diagram of the simulation according to one example of the claimed invention. The process begins in step 302 and immediately proceeds to step 304. In step 304, data elements, each associated with a criteria, are assessed. The criteria is used to project expected oil and gas production from gas wells. The criteria include a number of crews to perform the jobs and a total number of jobs. The process continues to step 306.

In step 306, the data elements which have been accessed are converted into a uniform data format within each of the associated criteria. Example formats include alpha-numeric, currency, exponential numbers, decimal numbers, floating-point numbers, and more. The process continues to step 308.

In step 308, the simulation loops begin by executing a total number of simulations (M) in parallel. Shown is an inner loop per simulation loop 310, 312, 314 and an outer per project loop 316, 318, each of which is further described below.

The project loop may include several steps not shown. These steps include prompting the user, which algorithm or agent to run random or greedy and the number of simulations (M)

For the inner loop, in step 310, each job to be performed is evaluated, and which crews are available to perform the jobs. The inner loop continues to step 312. In step 312, an algorithm is executed to produce results, wherein the results include a schedule of crews and jobs and a production timeline. The inner loop continues to step 314 in which a test is made. In step 314, a test is made to determine if a total number of jobs is completed or a time period expires. If the test returns a false value, the process continues the inner loop by returning to step 308 above. Otherwise, if the test returns true, meaning that the total number of jobs is complete or the time expired, the process continues to the outer loop in step 316.

In step 316, the results from the total number of simulations (M) are ranked with the highest gas production. The process continues to step 318.

In step 318, a portion of the results with the highest gas production is sent to a display, and the process ends in step 320.

### Simulation Results and User Interface

FIG. 4A and FIG. 4B through FIG. 6A and FIG. 6B are a series of simulation results using the claimed scheduling system according to one example of the present invention. Turning to FIG. 4A and FIG. 4B, shown is a scatter plot 402 of net dry gas production on the Y-axis and NPV on the X-axis. Every single point on this scatter plot represents one loop through the inner loop (per simulation loop) of FIG. 3. This plot 402 helps determine where each of these simulations rank relative to each other. This scatter plot 402 illustrates that the more gas a single simulation produces, the higher the NPV.

Shown are two side-by-side panels 408, 410, with a Gantt chart and corresponding data overhead for a five-year period between 2021 and 2025. Point X1 404 corresponds to EBITDA (Earnings Before Interest, Taxes, Depreciation, And Amortization) Gantt Schedules 408 and the data above, and point X2 406 corresponds to EBITDA Gantt Schedules 410 and the data above. The comparison of point X1 versus X2 is shown with the other metrics for each directly above. No two simulations are going to be identical because of changes in input data. Note all the points X1, X2 and others are selectable by a user to see the details of a particular episode or a run.

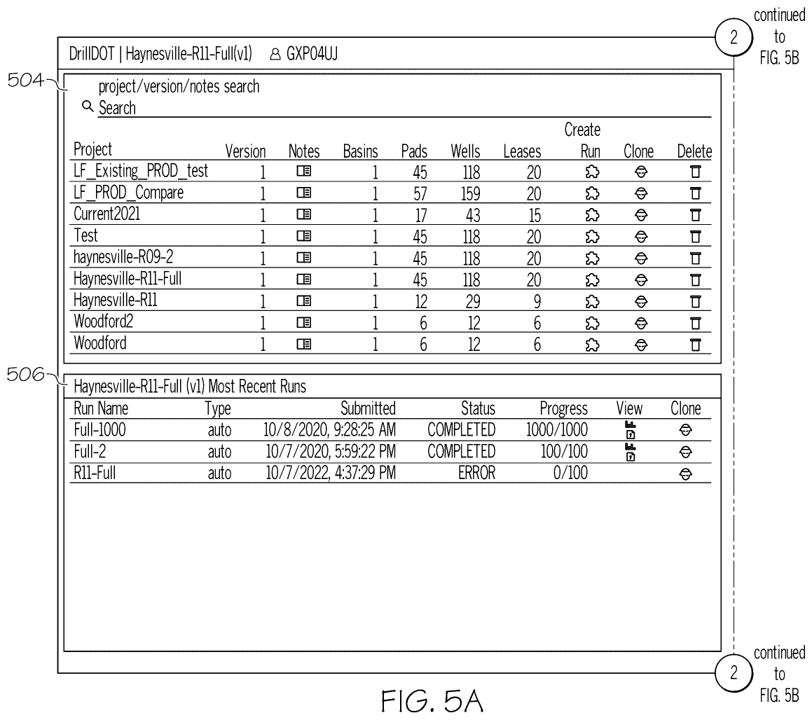

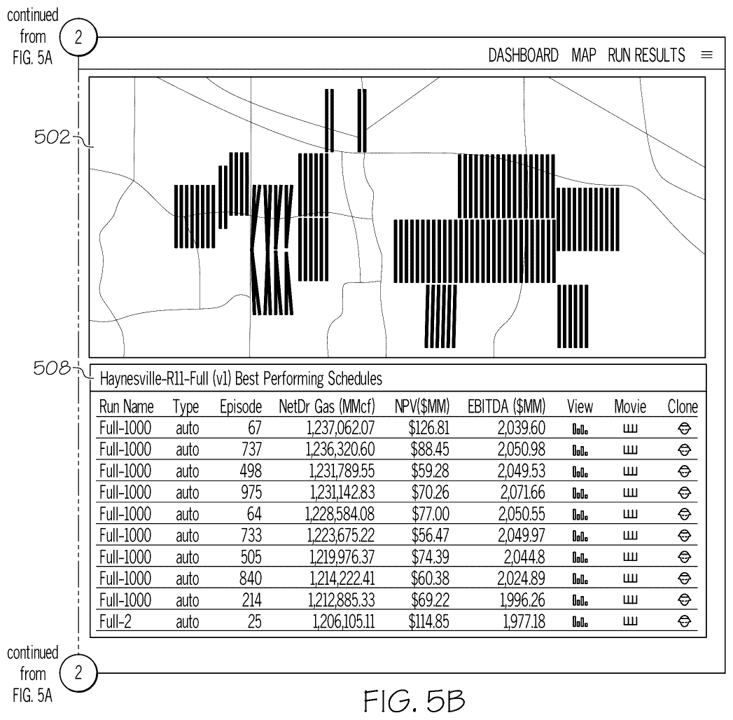

Turning now to FIG. 5A and FIG. 5B, shown is a user interface with four quadrants, according to one example of the present invention. Quadrant 502 is identical to FIG. 2, i.e., an aerial map with an overlay of potential drilling alternatives for a given geographic area. Quadrant 504 is all the projects in the database. In this case, Haynesville-R11-Full in quadrant 504 is shown highlighted and displayed in quadrant 502. Quadrant 504 also shows different information for each well area, including pads, number of leases, number of well, etc.

Quadrant 506 all the runs through the claimed scheduling system for a selected oil and natural gas well in quadrant 504. Again, each run will have different settings and inputs, e.g., a different number of crews or pricing and the number of episodes. The best performing results for the Haynesville-R11-Full in quadrant 504 are shown in quadrant 508. Each simulation may be using different pricing or a different number of crews. In this example, the best-performing episode or run for this top one, i.e., simulation number of episode 67. The data associated with this best-performing run is also shown in the corresponding row.

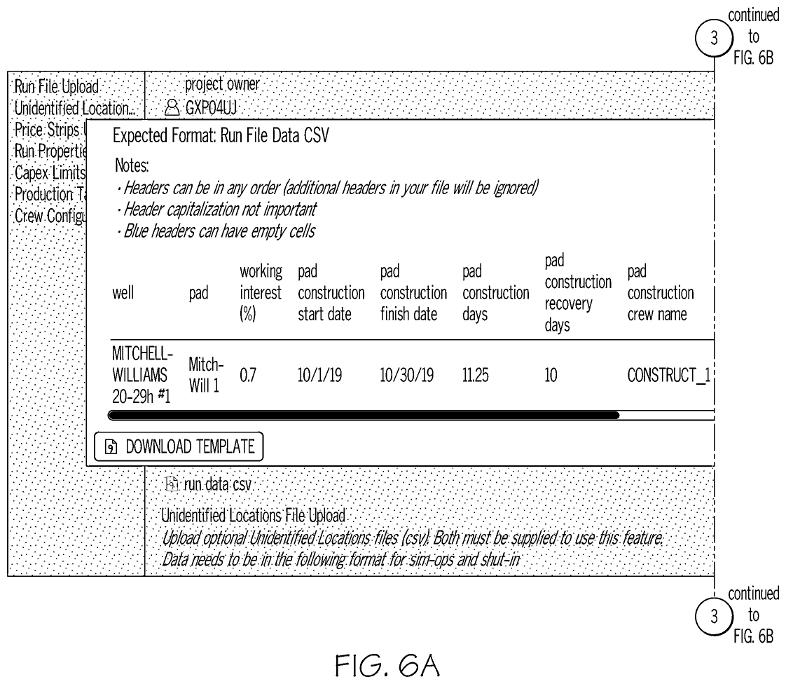

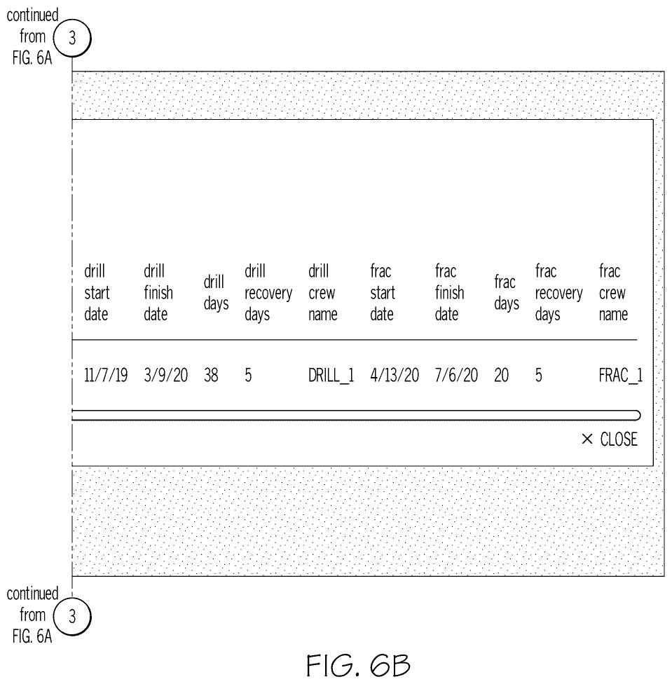

Turning to FIG. 6A and FIG. 6B, shown is an expected run format to check for each data element, according to one example of the present invention. Here is a pop-up 602 to allow the user to specify a data format for each data element. For example, some data elements can be empty cells, other data elements percentages, and others decimal values. This is an additional check and filter to ensure the data elements are formatted correctly. In one example, the user populates an empty version of this of an Excel file, and then once the user is done, they upload to the claimed scheduling system, and it performs another check to make sure enforce data formats

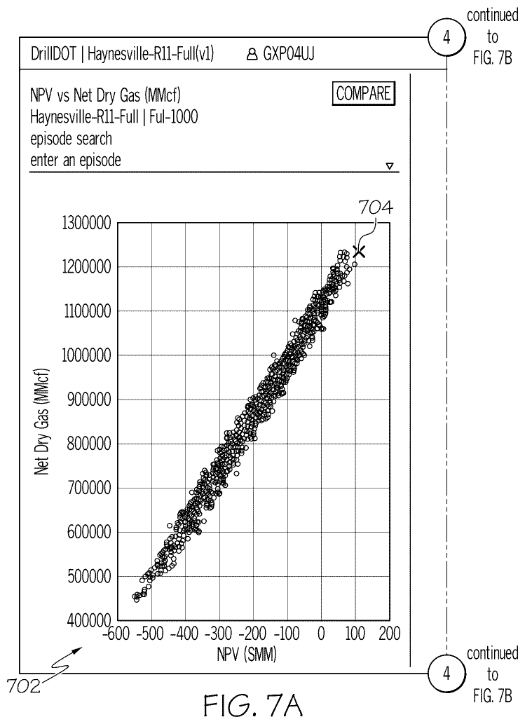

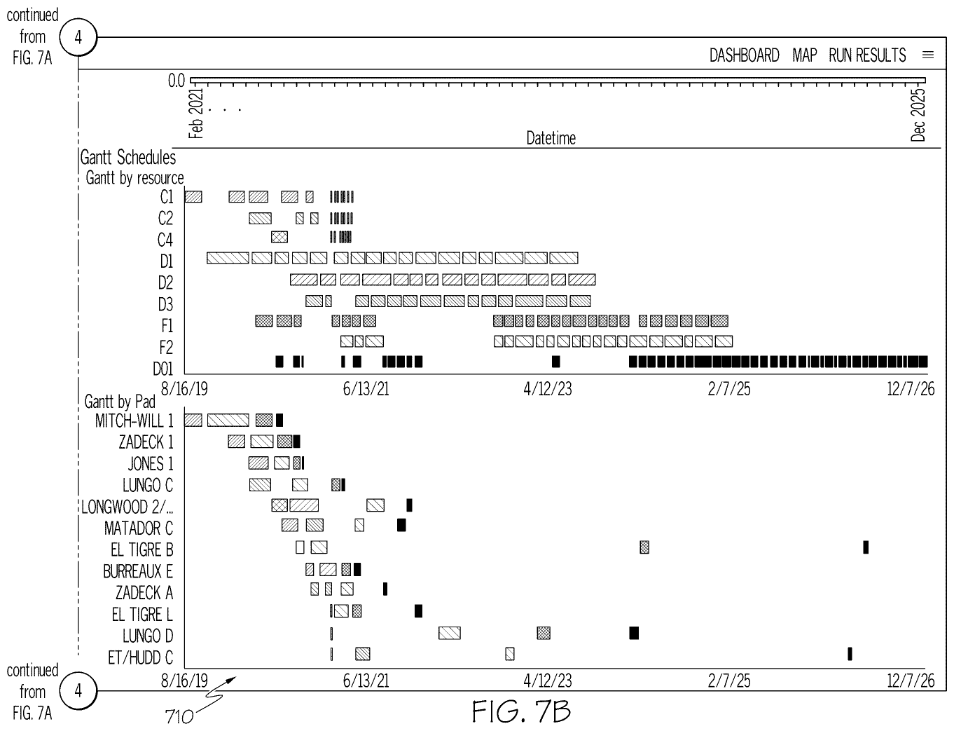

Turning to FIG. 7A and FIG. 7B, is another user-interface example with Gantt schedules for a given episode or run, according to an example of the present invention. More specifically shown is a scatter plot 702 like the scatter plot 404 described for FIG. 4A and FIG. 4B. At Point X 704 in scatter plot 702 shown on the right are Gantt schedules 708, 710 for a given period of time 706. More specifically, a Gantt Schedule by resource, i.e., crew C1, C2, C3, etc., 708 and a Gantt Schedule by pad 710. Note again that the points X and others are selectable by a user to see the details of a particular episode or a run.

FIG. 7A and FIG. 7B is the encapsulation of all the jobs. It's constantly checking with constraints.

### General Computer for Implementing Algorithm

The present invention can be implemented on a standalone computer system, a server, a web-server, a cloud computer system or a hybrid cloud system, or other on-demand availability of computer system resources, especially data storage and computing power, without direct active management by the user.

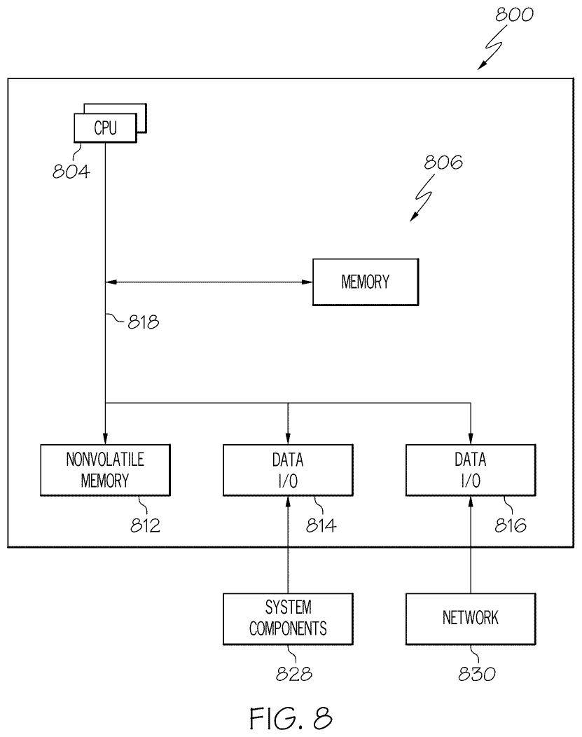

FIG. 8 illustrates a block diagram illustrating a processing system 800 for carrying out a portion of the present invention, according to an example. The processor system 800 is an example of a processing subsystem that is able to perform any of the above-described processing operations, other operations, or combinations of these, such as the flow diagram of FIG. 3.

The processor 800 in this example includes a hardware processor or CPU 804 that is communicatively connected to a main memory 806 (e.g., volatile memory), a non-volatile memory 812 to support processing machine instruction and operations. The CPU is further communicatively coupled to a network adapter hardware 816 to support input and output communications with external computing systems such as through the illustrated network 830.

The processor 800 further includes a data input/output (I/O) processor 814 that is able to be adapted to communicate with any type of equipment, such as the illustrated system components 828. The data input/output (I/O) processor, in various examples, is able to be configured to support any type of data communications connections, including present-day analog and/or digital techniques or via a future communications mechanism. A system bus 818 interconnects these system components.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code, or notation, of a set of instructions intended to cause a system having an information processing capability to perform a particular function either directly or after either or both of the following a) conversion to another language, code or, notation, and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above-described methods and realize the above-described systems.

### Non-Limiting Examples

Although specific embodiments of the subject matter have been disclosed, those having ordinary skill in the art will understand that changes are made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A computer-implemented method for improving a natural gas drill and completion schedule, the method comprising:
performing a plurality of project projections by:
accessing a plurality of data elements, each associated with one of a plurality of criteria, and each of the plurality of criteria is used to project expected gas production from at least one of a plurality of gas wells, and the plurality of criteria includes a number of crews to perform jobs, and a total number of jobs;
converting each of the plurality of data elements into a uniform data format within the each of the associated criteria;
executing a total number of simulations (M) in parallel up to the total number of jobs or until a time period expires by,
evaluating each of the total number of jobs to be performed and which crews are available to perform jobs; and
executing an algorithm to produce results, wherein the results include a schedule of crews and jobs and a production timeline;
ranking the results from the total number of simulations (M) with a highest gas production; and
sending, to a display, at least a portion of the results with the highest gas production.

2. The computer-implemented method of claim 1, wherein the total number of simulations, the time period, or both are settable by a user.

3. The computer-implemented method of claim 1, wherein the plurality of criteria used to project expected gas production includes 1) location of a gas well, 2) expected length of a gas well, 4) a location of a pad, 5) an identifier of a basin to which a pad belongs, 6) an identifier of a lease for any timing constraints, 7) types of jobs at a pad, 8) a number of days allocated to perform job, 9) a number of days each pad is in a recovery state, or 10) any combination thereof.

4. The computer-implemented method of claim 1, wherein the sending to a display at least a last set of corresponding components includes 1) a table of jobs, with a crew performing the job and start and end times for each job, 2) an expected cash flow time-series, 3) an expected production time-series, 4) events table that specifies a date of initial production of each well and any shut-ins that occur in that schedule with their duration and production impact, 6) constraint violations, 7) water usage, 8) net present value (NPV) of gas production, 8) internal rate of return (IRR) of gas production or 10) any combination thereof.

5. The computer-implemented method of claim 1, wherein the algorithm is an epsilon-greedy algorithm or a random algorithm.

6. The computer-implemented method of claim 1, wherein the algorithm is selectable by a user.

7. The computer-implemented method of claim 5, wherein the results from each step using the epsilon-greedy algorithm is given by:
$${score}_{p} = {exp}^{ϵ * {weight}_{p}} / {\sum }_{n = 1}^{P} {exp}^{ϵ * {weight}_{p}}$$
$${weight}_{p} = ( {\sum }_{n = 1}^{N} {w}_{n} {x}_{n} / {\sum }_{n = 1}^{N} {w}_{n} ) ∀ P$$
where p is a pad in a set P of all pads being scored, wₙ is a user-specified weight of each of the plurality of criteria N and xₙ is a computed value of each of i) maximum expected production from each pad, ii) distance from each pad to all other pads, iii) estimated binary likelihood of a frack hit, and iv) time remaining before the pad must be developed.

8. The computer-implemented method of claim 7, wherein the wₙ is assigned by a user using a graphical user interface.

9. The computer-implemented method of claim 1, wherein the sending, to a display, further includes creating a Gantt chart with a vertical axis denoting a location of a pad and a horizontal axis includes types of jobs at the pad denoted in various colors.

10. A system for improving a natural gas drill and completion schedule, the system comprising:
a computer memory capable of storing machine instructions; and
a hardware processor in communication with the computer memory, the hardware processor configured to access the computer memory to execute the machine instructions for performing a plurality of project projections by:
accessing a plurality of data elements, each associated with one of a plurality of criteria, and each of the plurality of criteria is used to project expected gas production from at least one of a plurality of gas wells, and the plurality of criteria includes a number of crews to perform jobs, and a total number of jobs;
converting each of the plurality of data elements into a uniform data format within the each of the associated criteria;
executing a total number of simulations (M) in parallel up to the total number of jobs or until a time period expires by,
evaluating each of the total number of jobs to be performed and which crews are available to perform jobs; and
executing an algorithm to produce results, wherein the results include a schedule of crews and jobs and a production timeline;
ranking the results from the total number of simulations (M) with a highest gas production; and
sending, to a display, at least a portion of the results with the highest gas production.

11. The system of claim 10, wherein the total number of simulations, the time period, or both are settable by a user.

12. The system of claim 10, wherein the plurality of criteria used to project expected gas production includes 1) location of a gas well, 2) expected length of a gas well, 4) a location of a pad, 5) an identifier of a basin to which a pad belongs, 6) an identifier of a lease for any timing constraints, 7) types of jobs at a pad, 8) a number of days allocated to perform job, 9) a number of days each pad is in a recovery state, or 10) any combination thereof.

13. The system of claim 10, wherein the sending to a display at least a last set of corresponding components includes 1) a table of jobs, with a crew performing the job and start and end times for each job, 2) an expected cash flow time-series, 3) an expected production time-series, 4) events table that specifies a date of initial production of each well and any shut-ins that occur in that schedule with their duration and production impact, 6) constraint violations, 7) water usage, 8) net present value (NPV) of gas production, 8) internal rate of return (IRR) of gas production or 10) any combination thereof.

14. The system of claim 10, wherein the algorithm is an epsilon-greedy algorithm or a random algorithm

15. The system of claim 10, wherein the algorithm is selectable by a user.

16. The system of claim 14, wherein the results from each step using the epsilon-greedy algorithm is given by:
$${score}_{p} = {exp}^{ϵ * {weight}_{p}} / {\sum }_{n = 1}^{P} {exp}^{ϵ * {weight}_{p}}$$
$${weight}_{p} = ( {\sum }_{n = 1}^{N} {w}_{n} {x}_{n} / {\sum }_{n = 1}^{N} {w}_{n} ) ∀ P$$
where p is a pad in a set P of all pads being scored, wₙ is a user-specified weight of each of the plurality of criteria N and xₙ is a computed value of each of i) maximum expected production from each pad, ii) the work already completed on the pad if any, iii) an estimated likelihood of a frack hit and iv) time remaining before the pad must be developed.

17. The system of claim 16, wherein the wₙ is assigned by a user using a graphical user interface.

18. The system of claim 10, wherein the sending, to a display, further includes creating a Gantt chart with a vertical axis denoting a location of a pad and a horizontal axis includes types of jobs at the pad denoted in various colors.

19. A system for improving a natural gas drill and completion schedule, the system comprising:
a computer memory capable of storing machine instructions; and
a hardware processor in communication with the computer memory, the hardware processor configured to access the computer memory to execute the machine instructions for performing a plurality of project projections by:
accessing a plurality of data elements, each associated with one of a plurality of criteria, and each of the plurality of criteria is used to project expected gas production from at least one of a plurality of gas wells, and the plurality of criteria includes a number of crews to perform jobs, and a total number of jobs, wherein the plurality of criteria used to project expected gas production includes 1) location of a gas well, 2) expected length of a gas well, 4) a location of a pad, 5) an identifier of a basin to which a pad belongs, 6) an identifier of a lease for any timing constraints, 7) types of jobs at a pad, 8) a number of days allocated to perform job, 9) a number of days each pad is in a recovery state, or 10) any combination thereof;
converting each of the plurality of data elements into a uniform data format within the each of the associated criteria;
executing a total number of simulations (M) in parallel up to the total number of jobs or until a time period expires by,
evaluating each of the total number of jobs to be performed and which crews are available to perform jobs; and
executing an algorithm to produce results, wherein the results include a schedule of crews and jobs and a production timeline, wherein the algorithm is an epsilon-greedy algorithm or a random algorithm and the algorithm is selectable by a user, wherein the total number of simulations, the time period, or both are settable by a user;
ranking the results from the total number of simulations (M) with a highest gas production,
wherein sending, to a display, further includes at least a last set of corresponding components includes 1) a table of jobs, with a crew performing the job and start and end times for each job, 2) an expected cash flow time-series, 3) an expected production time-series, 4) events table that specifies a date of initial production of each well and any shut-ins that occur in that schedule with their duration and production impact, 6) constraint violations, 7) water usage, 8) net present value (NPV) of gas production, 8) internal rate of return (IRR) of gas production or 10) any combination thereof;
wherein the sending, to a display, further includes creating a Gantt chart with a vertical axis denoting a location of a pad and a horizontal axis includes types of jobs at the pad denoted in various colors.

20. The system of claim 19, wherein the results from each step using the epsilon-greedy algorithm is given by:
$${score}_{p} = {exp}^{ϵ * {weight}_{p}} / {\sum }_{n = 1}^{P} {exp}^{ϵ * {weight}_{p}}$$
$${weight}_{p} = ( {\sum }_{n = 1}^{N} {w}_{n} {x}_{n} / {\sum }_{n = 1}^{N} {w}_{n} ) ∀ P$$
where p is a pad in a set P of all pads being scored, wₙ is a user-specified weight of each of the plurality of criteria N and xₙ is a computed value of each of i) maximum expected production from each pad, ii) the work already completed on the pad if any, iii) an estimated likelihood of a frack hit and iv) time remaining before the pad must be developed and wherein the wₙ is assigned by a user using a graphical user interface.
